(19) United States
(12) Patent Application Publication
(10) Pub. No.: US 2022/0336839 A1
(43) Pub. Date: Oct. 20, 2022

(54) COMPOSITE DEVICE AND LAMINATING MACHINE

(71) Applicant: WUXI LEAD INTELLIGENT EQUIPMENT CO., LTD., Wuxi (CN)

(72) Inventor: Junfu YAO, Wuxi (CN)

(21) Appl. No.: 17/857,091

(22) Filed: Jul. 4, 2022

Related U.S. Application Data
(63) Continuation of application No. PCT/CN2021/123877, filed on Oct. 14, 2021.

(30) Foreign Application Priority Data
Feb. 9, 2021 (CN) 202120368255.9

(51) Int. Cl. H01M 10/04; B23K 26/38

(52) U.S. Cl. CPC H01M 10/0404; B23K 26/38

(57) ABSTRACT

The present application relates to a composite device, including a first electrode material strip unwinding mechanism configured to unwind the first electrode material strip; a crease mechanism disposed downstream of the first electrode material strip unwinding mechanism and configured to form a plurality of creases on the first electrode material strip; and a first composite mechanism disposed downstream of the crease mechanism and configured to combine a first diaphragm, a second diaphragm, and the first electrode material strip so as to stack the first diaphragm, the second diaphragm, and the first electrode material strip to form a first composite material strip. By arranging the composite device, during a process of folding the first composite material strip, it may be directly folded along the creases. The composite device uses belt-shaped pole sheets directly without cutting, which improves efficiency of subsequent lamination. The present application also relates to a laminating machine.

### CROSS-REFERENCE TO RELATED APPLICATION

This application is a US national phase application based upon an International Application No. PCT/CN2021/123877, filed on Oct. 14, 2021, which claims priority to Chinese Patent Application No. 202120368255.9, titled “COMPOSITE DEVICE AND LAMINATING MACHINE”, filed on Feb. 9, 2021, the disclosure of which is incorporated herein by reference in its entirety.

### FIELD OF DISCLOSURE

The present application relates to a technical field of lithium battery manufacturing, and more specifically, to a composite device and a laminating machine.

### BACKGROUND

A manufacturing process of a lithium battery includes a step of laminating. In a current laminating step, belt-shaped pole sheets are usually cut to form sheet materials, and the sheet materials are attached to diaphragms to form a composite material strip, and then the composite material strip is folded by a laminating device to complete the laminating step. As the belt-shaped pole sheets need to be cut to form sheet materials with same size, and then the sheet materials are attached to the diaphragms, and finally folded by the laminating device, efficiency is low.

### SUMMARY

Based on this, it is necessary to provide a composite device and a laminating machine with high laminating efficiency in view of a problem of low laminating efficiency in the prior art.

There is provided a composite device, including:

a first electrode material strip unwinding mechanism, configured to unwind a first electrode material strip;
a crease mechanism disposed downstream of the first electrode material strip unwinding mechanism and configured to form a plurality of creases spaced apart along a length direction of the first electrode material strip and extending along a width direction of the first electrode material strip on the first electrode material strip in a path; and
a first composite mechanism disposed downstream of the crease mechanism and configured to combine a first diaphragm and a second diaphragm on opposite sides of the first electrode material strip to form a first composite material strip.

By arranging the above-mentioned composite device, the crease mechanism forms the plurality of creases on the first electrode material strip, and the first diaphragm and the second diaphragm are attached to opposite sides of the first electrode material strip to form the first composite material strip. During a process of folding the first composite material strip, it may be directly folded along the creases. Compared with the prior art of firstly cutting off pole sheets into sheet materials and then laminating them, the composite device uses belt-shaped pole sheets directly without cutting, which effectively improves an efficiency of subsequent lamination. Meanwhile, more burrs may be prevented from cutting the pole sheets, so that quality of batteries is improved.

According to an embodiment of the present application, the composite device further includes a first diaphragm unwinding mechanism and a second diaphragm unwinding mechanism, and the first diaphragm unwinding mechanism and the second diaphragm unwinding mechanism are both disposed upstream of the first composite mechanism; the first diaphragm unwinding mechanism is configured to unwind the first diaphragm, and the second diaphragm unwinding mechanism is configured to unwind the second diaphragm.

According to an embodiment of the present application, the crease mechanism includes a laser cutting head or a cutter.

According to an embodiment of the present application, the creases are penetrating holes sequentially spaced apart along a width direction of the first electrode material strip and penetrating the first electrode material strip along a thickness direction of the first electrode material strip.

According to an embodiment of the present application, the penetrating holes include one or more of circular holes, rectangular holes or strip holes.

According to an embodiment of the present application, the creases are folded areas extending longitudinally along a width direction of the first electrode material strip, and a thickness of the folded areas of the first electrode material strip is less than a thickness of other positions of the first electrode material strip.

There is also provided a laminating machine including the above-mentioned composite device.

According to an embodiment of the present application, a folded sheet is formed between two adjacent creases on the first electrode material strip;

the laminating machine further includes a first sheet material device, a second sheet material device and a second composite mechanism, the first sheet material device is configured to dispose a plurality of first sheet materials on a side surface of the first composite material strip, and the second sheet material device is configured to dispose a plurality of second sheet materials on another side surface of the first composite material strip; and the first sheet materials and the second sheet materials are alternately spaced apart along the length direction of the first composite material strip, and two adjacent first sheet materials and second sheet materials along the length direction of the first composite material strip correspond to two adjacent folded sheets, respectively;
the second composite mechanism is disposed downstream of the first sheet material device and the second sheet material device and is configured to combine the first sheet material and the second sheet material with the first composite material strip, so that the first sheet material and the second sheet material are attached to the first composite material strip to form a second composite material strip.

According to an embodiment of the present application, the second composite material strip includes a plurality of first stacking components and a plurality of second stacking components, and the first stacking components and the second stacking components are alternately connected; the first stacking components include the first sheet material, the first diaphragm, the folded sheet, and the second diaphragm that are stacked in sequence, and the second stacking components include the second sheet material, the second diaphragm, the folded sheet, and the first diaphragm that are stacked in sequence;

the laminating machine further includes a first laminating device, the first laminating device is disposed downstream of the second composite mechanism and is configured to perform folding on the second composite material strip along the creases, so that a battery cell is formed by alternately stacking the plurality of first stacking components and the plurality of second stacking components.

According to an embodiment of the present application, a folded sheet is formed between two adjacent creases on the first electrode material strip;

the laminating machine further includes a first sheet material device, a second sheet material device and a second composite mechanism; the first sheet material device is configured to dispose a plurality of first sheet materials on a side surface of the first composite material strip, the second sheet material device is configured to dispose a plurality of second sheet materials on another side surface of the first composite material strip, and the first sheet material and the second sheet material are disposed on two sides of one of two adjacent folded sheets;
the second composite mechanism is disposed downstream of the first sheet material device and the second sheet material device and is configured to combine the first sheet material and the second sheet material with the first composite material strip, so that the first sheet material and the second sheet material are attached to the first composite material strip to form a third composite material strip.

According to an embodiment of the present application, the third composite material strip includes a plurality of third stacking components and a plurality of fourth stacking components, and the third stacking components and the fourth stacking components are alternately connected; the third stacking components include the first sheet material, the first diaphragm, the folded sheet, the second diaphragm, and the second sheet material that are stacked in sequence, and the fourth stacking components include the first diaphragm, the folded sheet, and the second diaphragm that are stacked in sequence; the laminating machine further includes a third laminating device, and the third laminating device is disposed downstream of the second composite mechanism and is configured to fold the third composite material strip along the creases, so that the plurality of third stacking components and the plurality of fourth stacking components are alternately stacked to form a battery cell.

According to an embodiment of the present application, a folded sheet is formed between two adjacent creases on the first electrode material strip;

the laminating machine further includes a fourth laminating device, and the fourth laminating device is disposed downstream of the first composite mechanism and is configured to fold the first composite material strip along the creases, and during a folding process, a third sheet material is placed on the first diaphragm and the second diaphragm in sequence, so that the first diaphragm, the folded sheet, the second diaphragm and the third sheet material are sequentially stacked to form a battery cell.

### BRIEF DESCRIPTION OF DRAWINGS

In order to illustrate embodiments of the present application or a technical solution in the prior art clearly, the accompanying drawings that need to be used in a description of the embodiments or the prior art will be briefly described as follows. It should be apparent that the drawings in the following description merely illustrate some embodiments of the present application. For those skilled in the art, other drawings may be acquired according to the disclosed drawings without devoting efforts.

FIG. 1 is a schematic structural diagram of a composite device provided by an embodiment of the present application.

FIG. 2 is a schematic structural diagram of a first electrode material strip processed by a crease mechanism in the composite device shown in FIG. 1.

FIG. 3 is a schematic structural diagram of a laminating machine provided in a first embodiment of the present application.

FIG. 4 is a schematic structural diagram of a laminating machine provided in a second embodiment of the present application.

FIG. 5 is a schematic structural diagram of the laminating machine in a state provided in a third embodiment of the present application.

FIG. 6 is a schematic structural diagram of the laminating machine shown in FIG. 5 in another state.

FIG. 7 is a schematic structural diagram of the laminating machine shown in FIG. 5 in yet another state.

FIG. 8 is a schematic structural diagram of the laminating machine provided in a fourth embodiment of the present application.

### DETAILED DESCRIPTION

To make the purpose, technical solutions and advantages of this application clearer, the application will be further described in detail below in conjunction with the accompanying figures and embodiments. In the following description, numerous specific details are set forth in order to fully understand the present application. However, this application can be in many other ways than those described herein. Those skilled in the art can make similar promotion without departing from the present disclosure connotation case. Accordingly, this application is therefore not limited to the specific embodiments disclosed below.

In the description of the present application, it is to be understood that terms such as “center”, “longitudinal”, “lateral”, “length”, “width”, “thickness”, “upper”, “lower”, “front”, “back”, “left”, “right”, “vertical”, “horizontal”, “top”, “bottom”, “inner”, “outer”, “clockwise”, “counterclockwise”, “axial”, “radial”, “circumferential” should be construed to refer to the orientation as then described or as shown in the drawings under discussion. These relative terms are for convenience of description only and do not require that the present application be constructed or operated in a particular orientation. Accordingly, this application should not therefore be construed as a limitation on the present application.

In addition, terms such as “first” and “second” are used herein for purposes of description and are intended to indicate or imply relative importance or significance or to imply the number of indicated technical features. Thus, the feature defined with “first”, “second” may explicitly or implicitly include at least one of the features. Further, in the description of the present application, “multiple” means at least two, such as two, three, etc., unless clearly specified otherwise.

In the present application, unless clearly specified or limited otherwise, terms “mounted”, “connected”, “coupled”, “fixed” and the like are used in a broad sense, and may include, for example, fixed connections, detachable connections, or integral connections; may also be mechanical or electrical connections; may also be direct connections or indirect connections via intervening structures; may also be inner communications of two elements, as can be understood by those skilled in the art depending on specific contexts.

In the present application, unless clearly specified or limited otherwise, a structure in which a first feature is “on” or “below” a second feature may include an embodiment in which the first feature in direct contact with the second feature, and may also include an embodiment in which the first feature and the second feature are not in direct contact with each other, but are contacted via an additional feature formed therebetween. Furthermore, a first feature “on”, “above” and “on top of” a second feature may include an embodiment in which the first feature is right or obliquely “on”, “above” or “on top of” the second feature, or simply means that the first feature is at a height higher than that of the second feature. While a first feature “below”, “under” or “on bottom of” a second feature may include an embodiment in which the first feature is right or obliquely “below”, “under” or “on bottom of” the second feature, or simply means that the first feature is at a height lower than that of the second feature.

It should be noted that when a component is stated as “located on” “disposed on” or “provided on” another component, it can be directly or indirectly in contact with another component. When a component is stated as “connected to” another component, it can be directly connected to another component or indirectly connected to another component. Terms such as “vertical”, “horizontal”, “upper”, “lower”, “left”, “right” and the like, as used herein, are merely for the purpose of illustration but not intended to be the only implementation form of the present application.

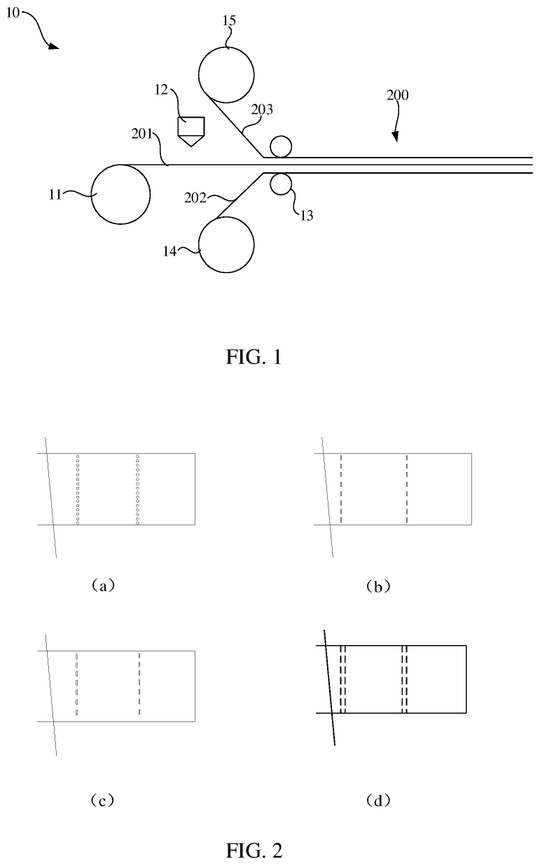

As shown in FIG. 1, a composite device 10 provided by an embodiment of the present application includes a first electrode material strip unwinding mechanism 11, a crease mechanism 12, and a first composite mechanism 13. The first electrode material strip unwinding mechanism 11 is configured to unwind a first electrode material strip 201, the crease mechanism 12 is disposed downstream of the first electrode material strip unwinding mechanism 11, and the first composite mechanism 13 is disposed downstream of the crease mechanism 12.

The crease mechanism 12 is configured to form a plurality of creases spaced apart along a length direction of a first electrode material strip 201 and extending along a width direction on the first electrode material strip 201, and the first composite mechanism 13 is configured to combine a first diaphragm 202 and a second diaphragm 203 on opposite sides of the first electrode material strip 201 to form a first composite material strip 200.

The first electrode material strip 201 is a belt-shaped pole sheet.

By arranging the above-mentioned composite device 10, the crease mechanism 12 forms the plurality of creases on the first electrode material strip 201, and the first diaphragm 202 and the second diaphragm 203 are attached to two sides of the first electrode material strip 201 to form the first composite material strip 200. During a process of folding the first composite material strip 200, it may be directly folded along the creases. Compared with the prior art of firstly cutting off pole sheets into sheet materials and then laminating them, the composite device 10 uses belt-shaped pole sheets directly without cutting, which effectively improves efficiency of subsequent lamination. Meanwhile, more burrs may be prevented from cutting the pole sheets, so that quality of batteries is improved.

It should be noted that the composite device 10 is configured to form the first composite material strip 200. In this embodiment, the first electrode material strip 201 of the first composite material strip 200 has the plurality of creases, so as to facilitate subsequent folding. When the first composite material strip 200 is folded, a pole sheet may be laid on the first composite material strip 200 and then folded to form a battery cell according to the actual process, which will not be repeated in this embodiment.

In addition, it should be noted that hardness of the pole sheet is greater than hardness of the first diaphragm 202 and the second diaphragm 203. An existing laminating method is to fold the pole sheet in view of a sheet material, whereas in this embodiment, it is convenient to fold the belt-shaped pole sheet, so the creases are formed on the first electrode material strip 201, namely, the belt-shaped pole sheet.

In some embodiments, the composite device 10 further includes a first diaphragm unwinding mechanism 14. The first diaphragm unwinding mechanism 14 is disposed upstream of a composite mechanism and is configured to unwind the first diaphragm 202. Furthermore, the composite device 10 further includes a second diaphragm unwinding mechanism 15. The second diaphragm unwinding mechanism 15 is disposed upstream of the composite mechanism and is configured to unwind the second diaphragm 203.

In some embodiments, the crease mechanism 12 includes a laser cutting head or a cutter, the laser cutting head or the cutter is configured to form the creases on the belt-shaped pole sheet along a width direction thereof, and the plurality of creases are evenly spaced apart along a length direction thereof.

It should be noted that, as shown in (a), (b), and (c) in FIG. 2, the creases on the belt-shaped pole sheet may be formed by penetrating holes opened on the pole sheet by using the laser cutting head or the cutter, and the penetrating holes are sequentially spaced apart along a width direction of the first electrode material strip 201 and penetrates the first electrode material strip 201 along a thickness direction thereof. The penetrating holes include one or more of circular holes, rectangular holes, and strip holes.

Definitely, as shown in (d) in FIG. 2, the creases may also be folded areas extending longitudinally along the width direction of the first electrode material strip 201, and a part of carbon powder in a dotted area is removed by laser, so that a carbon powder layer in this area is less than the carbon powder layer in other positions. That is, a thickness of the folded areas of the first electrode material strip 201 is less than a thickness of other positions of the first electrode material strip 201, resulting in weakening of strength of the areas, which facilitates folding.

In some embodiments, surfaces of opposite sides of the first diaphragm 202 and the second diaphragm 203 are provided with adhesives. After the first diaphragm 202 and the second diaphragm 203 of the first composite material strip 200 are initially attached to the belt-shaped pole sheet, through the heating and pressing of the first composite mechanism 13, namely compounding treatment, the adhesives are melted, and the first diaphragm 202 and the second diaphragm 203 are bonded together with the belt-shaped pole sheet to form the first composite material strip 200. Meanwhile, during subsequent folding, side surfaces of the first diaphragm 202 and the second diaphragm 203 facing away from the belt-shaped pole sheet are also secured with adhesion by adhesives.

The present application also provides a laminating machine, which includes the above-mentioned composite device 10, wherein after the crease mechanism 12 of the above-mentioned composite device 10 forms the plurality of creases on the first electrode material strip 201, a folded sheet is formed between two adjacent creases on the first electrode material strip 201.

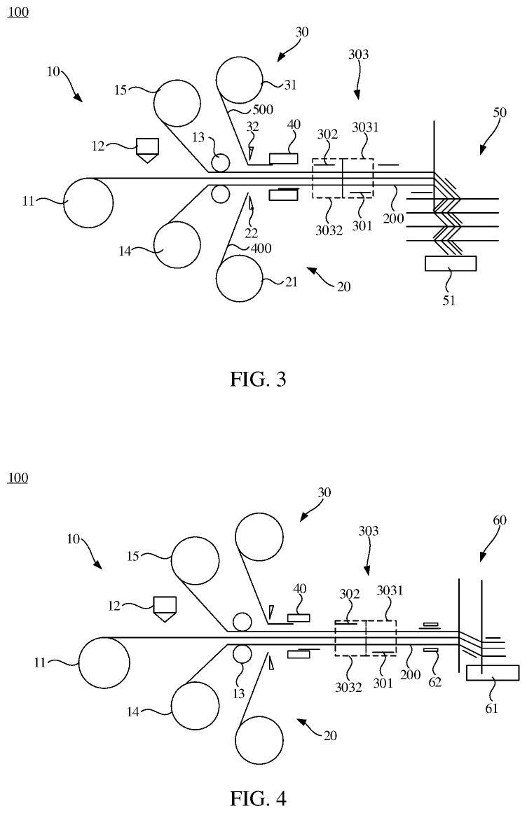

Referring to FIG. 3, in a first embodiment, the laminating machine 100 further includes a first sheet material device 20 and a second sheet material device 30. The first sheet material device 20 is configured to dispose a plurality of first sheet materials 301 on a side surface of the first composite material strip 200, and the second sheet material device 30 is configured to dispose a plurality of second sheet materials 302 on another side surface of the first composite material strip 200; and the first sheet materials 301 and the second sheet materials 302 are alternately spaced apart along a length direction of the first composite material strip 200, and two adjacent first sheet materials 301 and the second sheet materials 302 along the length direction of the first composite material strip 200 correspond to two adjacent folded sheets, respectively.

Wherein the first sheet material 301 and the second sheet material 302 are both pole sheet. When folding is performed along the creases between adjacent folded sheets, a battery cell in which the first sheet material 301, the first composite material strip 200, the second sheet material 302, and the first composite material strip 200 are stacked in sequence may be formed. The creases are formed on the belt-shaped pole sheet in advance, which facilitates folding and improves folding efficiency.

It should be noted that, in the embodiment shown in FIG. 3, when the first electrode material strip 201 is a negative electrode, the first sheet material 301 and the second sheet material 302 are both positive pole sheet. Whereas when the first electrode material strip 201 is a positive electrode, the first sheet material 301 and the second sheet material 302 are both negative pole sheet. The first diaphragm 202 and the second diaphragm 203 may be same.

Furthermore, the first sheet material device 20 is configured to dispose a plurality of first sheet materials 301 on a side surface of the first diaphragm 202 facing away from the first electrode material strip 201, and the second sheet material device 30 is configured to dispose a plurality of second sheet materials 302 on a side surface of the second diaphragm 203 facing away from the first electrode material strip 201.

As a result, when folded, the battery cell is formed by sequentially stacking the first sheet material 301, the first diaphragm 202, the folded sheet, the second diaphragm 203, the second sheet material 302, the second diaphragm 203, the folded sheet, and the first diaphragm 202 in a predetermined number. Specifically, the first sheet material 301 (the second sheet material 302) is a pole sheet and is one of the positive electrode or the negative electrode, and the first electrode material strip 201 is another of the positive electrode or the negative electrode. After the first sheet material 301 and the second sheet material 302 are combined with the first composite material strip 200 and then folded repeatedly, a battery cell will be formed by sequentially and cyclically stacking a diaphragm, a positive pole sheet, a diaphragm, and a negative pole sheet.

It should be appreciated that the plurality of creases on the first electrode material strip 201 are evenly spaced apart along a length direction of the first electrode material strip 201, and each first sheet material 301 and each second sheet material 302 corresponds to the folded sheet, so all the first sheet materials 301 and all the second sheet materials 302 are evenly spaced apart along the length direction of the first electrode material strip 201, namely, along the length direction of the first composite material strip 200.

In practical application, a distance between two adjacent first sheet materials 301 along the length direction of the first composite material strip 200 is greater than a width of the second sheet materials 302, and a distance between two adjacent second sheet materials 302 along the length direction of the first composite material strip 200 is greater than a width of the first sheet materials 301.

It should be noted that, in FIG. 3, width directions of the first sheet material 301 and the second sheet material 302 are the length direction of the first composite material strip 200.

In this embodiment, the first sheet material device 20 includes a second electrode material strip unwinding mechanism 21 and a first cutting mechanism 22. The second electrode material strip unwinding mechanism 21 is configured to unwind a second electrode material strip 400. The first cutting mechanism 22 is disposed downstream of the second electrode material strip unwinding mechanism 21, and the first cutting mechanism 22 is configured to cut the second electrode material strip 400 to form the first sheet material 301.

Furthermore, the second sheet material device 30 includes a third electrode material strip unwinding mechanism 31 and a second cutting mechanism 32. The third electrode material strip unwinding mechanism 31 is configured to unwind a third electrode material strip 500. The second cutting mechanism 32 is disposed downstream of the third electrode material strip unwinding mechanism 31, and the second cutting mechanism 32 is configured to cut the third electrode material strip 500 to form the second sheet material 302.

It should be appreciated that the above-mentioned second electrode material strip 400 and third electrode material strip 500 are same as the first electrode material strip 201, and they are all belt-shaped pole sheets. After the second electrode material strip 400 and the third electrode material strip 500 are cut by the first cutting mechanism 22 and the second cutting mechanism 32 to form the first sheet material 301 and the second sheet material 302, respectively, the first sheet material 301 and the second sheet material 302 may be initially attached to the first diaphragm 202 and the second diaphragm 203, respectively. In an alternative way, the first sheet material 301 and the second sheet material 302 may be initially attached to the first diaphragm 202 and the second diaphragm 203 respectively by additionally disposing other mechanisms, which is not limited here.

In practical application, the laminating machine further includes a second composite mechanism 40. The second composite mechanism 40 is disposed downstream of the first sheet material device 20 and the second sheet material device 30 and is configured to combine the first sheet material 301 and the second sheet material 302 with the first composite material strip 200, so that the first sheet material 301 and the second sheet material 302 are attached to the first composite material strip 200 to form a second composite material strip 303.

In this embodiment, the second composite material strip 303 includes a plurality of first stacking components 3031 and a plurality of second stacking components 3032, and the first stacking components 3031 and the second stacking components 3032 are alternately connected. The first stacking components 3031 include the first sheet material 301, the first diaphragm 202, the folded sheet, and the second diaphragm 203 stacked in sequence, and the second stacking components 3032 include the first diaphragm 202, the folded sheet, the second diaphragm 203, and the second sheet material 302 stacked in sequence.

In this embodiment, the laminating machine further includes a first laminating device 50, and the first laminating device 50 is disposed downstream of the second composite mechanism 40 and is configured to perform folding on the second composite material strip 303 along the creases, so that the above-mentioned battery cell is formed by alternately stacking the plurality of first stacking components 3031 and the plurality of second stacking components 3032.

Furthermore, the first laminating device 50 includes a laminating platform 51, and the second composite material strip 303 is conveyed from top to bottom in a vertical direction and is folded on the laminating platform 51.

It should be noted that, in this embodiment, folding of the second composite material strip 303 may be realized by using an air blowing structure or a material pushing bracket in conjunction with gravity. Alternatively, the folding of the second composite material strip 303 may be realized by gravity directly.

When the air blowing structure is adopted, the air blowing structures are provided on two sides of the second composite material strip 303, and the air blowing structures are located above the laminating platform 51; and the air blowing structures on the two sides alternately blow air toward the second composite material strip 303 during a conveying process of the second composite material strip 303. As the first electrode material strip 201 has creases thereon, the second composite material strip 303 is blown by the air blowing structures to be bent, thereby ensuring that the second composite material strip 303 is folded on the laminating platform 51.

When the material pushing bracket is adopted, the material pushing brackets are provided on the two sides of the second composite material strip 303, and the material pushing brackets are located above the laminating platform 51; and the material pushing brackets on the two sides are staggered in a vertical direction. In addition, the material pushing brackets on the two sides may be close to each other, so as to exert an external force in opposite directions on the two adjacent folded sheets, so that the two adjacent folded sheets are bent, thereby ensuring that the second composite material strip 303 is folded on the laminating platform 51.

When directly relying on gravity, as the first electrode material strip 201 has creases thereon, and the second composite material strip 303 is conveyed downward to the laminating platform 51 in the vertical direction, the laminating platform 51 has two baffles. Under an action of gravity, the first electrode material strip 201 will be bent and folded at the creases due to restriction of the two baffles, so that the folding of the second composite material strip 303 is realized.

Referring to FIG. 4, in a second embodiment, the laminating machine 100 includes a first sheet material device 20, a second sheet material device 30, and a second composite mechanism 40. The first sheet material device 20 is configured to dispose a plurality of first sheet materials 301 on a side surface of the first composite material strip 200, and the second sheet material device 30 is configured to dispose a plurality of second sheet materials 302 on another side surface of the first composite material strip 200; and the first sheet materials 301 and the second sheet materials 302 are alternately spaced apart along a length direction of the first composite material strip 200, and two adjacent first sheet materials 301 and the second sheet materials 302 along the length direction of the first composite material strip 200 correspond to two adjacent folded sheets, respectively. The second composite mechanism 40 is disposed downstream of the first sheet material device 20 and the second sheet material device 30 and is configured to combine the first sheet material 301 and the second sheet material 302 with the first composite material strip 200, so that the first sheet material 301 and the second sheet material 302 are attached to the first composite material strip 200 to form a second composite material strip 303.

It should be appreciated that the first sheet material device 20, the second sheet material device 30, and the second composite mechanism 40 in this embodiment are same as the first sheet material device 20, the second sheet material device 30, and the second composite mechanism 40 in the first embodiment in terms of structures and functions. Therefore, same reference numerals are used to facilitate better understanding.

In this embodiment, the second composite material strip 303 includes a plurality of first stacking components 3031 and a plurality of second stacking components 3032, and the first stacking components 3031 and the second stacking components 3032 are alternately connected. The first stacking components 3031 include the first sheet material 301, the first diaphragm 202, the folded sheet, and the second diaphragm 203 stacked in sequence, and the second stacking components 3032 include the first diaphragm 202, the folded sheet, the second diaphragm 203, and the second sheet material 302 stacked in sequence.

In this embodiment, the laminating machine further includes a second laminating device 60, and the second laminating device 60 is disposed downstream of the second composite mechanism 40 and is configured to perform folding on the second composite material strip 303 along the creases, so that the battery cell is formed by alternately stacking the plurality of first stacking components 3031 and the plurality of second stacking components 3032.

It should be appreciated that in this embodiment, the first sheet material 301 (the second sheet material 302) is a pole sheet and is one of the positive electrode or the negative electrode, and the first electrode material strip 201 is another of the positive electrode or the negative electrode. After folding repeatedly, a battery cell will be formed by sequentially and cyclically stacking a diaphragm, a positive pole sheet, a diaphragm, and a negative diaphragm. In addition, a function of the second laminating device 60 in this embodiment is same as a function of the first laminating device 50 in the first embodiment.

Furthermore, the second laminating device 60 includes a laminating platform 61 and a clamping claw 62. The laminating platform 61 is disposed downstream of the second composite mechanism 40, and the laminating platform 61 can reciprocate along a vertical direction. The clamping claw 62 reciprocates between a material discharge end of the second composite mechanisms 40 and the laminating platform 61 and is configured to clamp the second composite material strip 303 and to fold the second composite material strip 303 and to place it on the laminating platform 61.

Taking a specific embodiment as an example to illustrate: initially, the second sheet material 302 is firstly arranged at a head end of the first composite material strip 200 by the second sheet material device 30, and then the first sheet material 301 is placed on the first composite material strip 200 by the first sheet material device 20, and next the second sheet material 302 and the first sheet material 301 are placed in sequence and are combined by the second composite mechanism 40 to form the second composite material strip 303.

In other words, the second stacking components 3032 of the second composite material strip 303 are located at a head end, and the second composite material strip 303 is composed by the plurality of second stacking components 3032 being alternately connected with the plurality of first stacking components 3031.

The clamping claw 62 grabs the second composite material strip 303 at the material discharge end of the second composite mechanism 40 and horizontally moves it to the laminating platform 61. At this time, the first diaphragm 202 of the first composite material strip 200 is in contact with the laminating platform 61, namely, the second stacking component 3032 at the head end is in contact with the laminating platform 61. While the laminating platform 61 descends, the clamping claw 62 returns to the material discharge end of the second composite mechanism 40 to continue to grab another second stacking component 3032. Next, the clamping claw 62 horizontally moves toward the laminating platform 61 to convey the grabbed second stacking component 3032 to the laminating platform 61. As the laminating platform 61 descends, the second stacking component 3032 at the head end of the second composite material strip 303 also descends accordingly. When the clamping claw 62 conveys the grabbed second stacking component 3032 to the laminating platform 61, the first stacking component 3031 adjacent to the second stacking component 3032 at the head end will cover the second stacking component 3032 at the head end; in addition, the grabbed second stacking component 3032 will also cover the first stacking component 3031, so as to perform folding.

It should be appreciated that a grabbing method of the clamping claw 62 is to grab at intervals of one stacking component, namely, there is an interval of one stacking component between the stacking component grabbed currently and the stacking component grabbed at a previous time. In a case of the second stacking components 3032 grabbed as described above, as the first stacking components 3031 and the second stacking components 3032 are alternately connected, when the clamping claw 62 grabs a second second stacking component 3032 directly above a previous second stacking component 3032, the first stacking component 3031 between the two second stacking components 3032 will be folded.

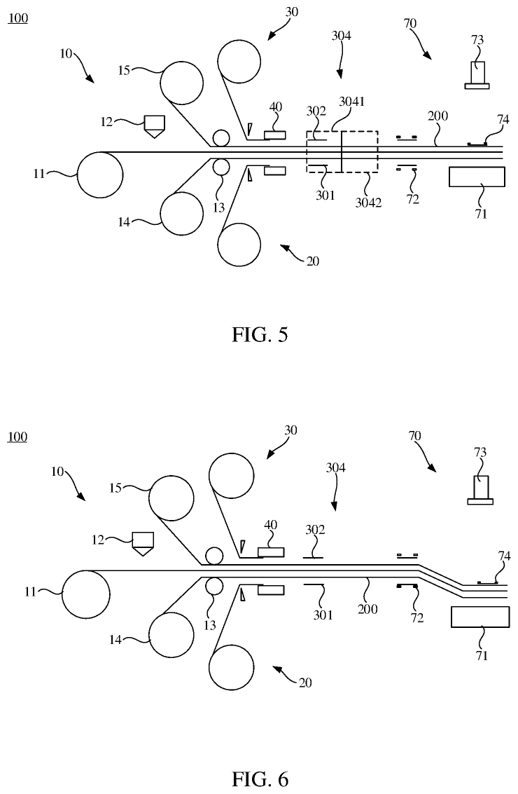

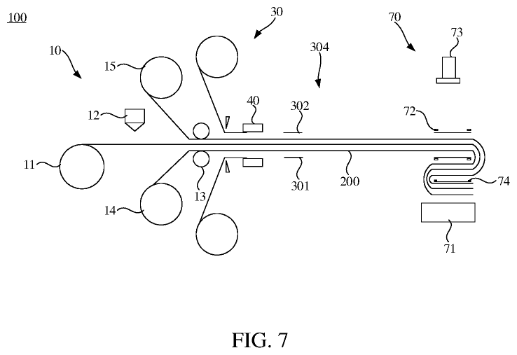

Referring to FIGS. 5-7, in a third embodiment, the laminating machine 100 further includes a first sheet material device 20, a second sheet material device 30, and a second composite mechanism 40. The first sheet material device 20 is configured to dispose a plurality of first sheet materials 301 on a side surface of the first composite material strip 200, the second sheet material device 30 is configured to dispose a plurality of second sheet materials 302 on another side surface of the first composite material strip 200, and the first sheet material 301 and the second sheet material 302 are disposed on two sides of one of two adjacent folded sheets. The second composite mechanism 40 is disposed downstream of the first sheet material device 20 and the second sheet material device 30 and is configured to combine the first sheet material 301 and the second sheet material 302 with the first composite material strip 200, so that the first sheet material 301 and the second sheet material 302 are attached to the first composite material strip 200 to form a third composite material strip 304.

In this embodiment, structures of the first sheet material device 20, the second sheet material device 30, and the second composite mechanism 40 are same as the first sheet material device 20, the second sheet material device 30, and the second composite mechanism 40 in the previous embodiment, and a difference is that, in this embodiment, the first sheet material device 20 and the second sheet material device 30 are both placed on opposite sides of the first composite material strip 200. Therefore, in this embodiment, the same reference numerals are used for the first sheet material device 20 and the second sheet material device 30 to facilitate better understanding, and the same reference numerals are also used for subsequent identical mechanisms and devices.

In this embodiment, the third composite strip 304 includes a plurality of third stacking components 3041 and a plurality of fourth stacking components 3042, and the third stacking components 3041 and the fourth stacking components 3042 are alternately connected. The third stacking components 3041 include the first sheet material 301, the first diaphragm 202, the folded sheet, the second diaphragm 203, and the second sheet material 302 stacked in sequence, and the fourth stacking components 3042 include the first diaphragm 202, the folded sheet, and the second diaphragm 203 stacked in sequence.

In this embodiment, the laminating machine further includes a third laminating device 70. The third laminating device 70 is disposed downstream of the second composite mechanism 40 and is configured to fold the third composite material strip 304 along the creases, so that the plurality of third stacking components 3041 and the plurality of fourth stacking components 3042 are alternately stacked to form a battery cell.

Furthermore, the third laminating device 70 includes a laminating platform 71 and a clamping claw 72. The laminating platform 71 is disposed downstream of the second composite mechanism 40, and the laminating platform 71 can reciprocate along a vertical direction. The clamping claw 72 reciprocates between a material discharge end of the second composite mechanism 40 and the laminating platform 71 and is used to clamp the third composite material strip 304 and to fold the third composite material strip 304 and to place it on the laminating platform 71.

In practical application, the third laminating device 70 further includes a pressing plate 73, and the pressing plate 73 can reciprocate in the vertical direction and is used to press against the battery cell on the laminating platform 71, so that the first sheet material 301, the first composite material strip 200, the second sheet material 302, and the first composite material strip 200 stacked in sequence are pressed tightly to ensure that each layer structure in the battery cell is tightly attached.

Specifically, the third laminating device 70 further includes a pressing member 74, and the pressing member 74 can move in the vertical direction along with the laminating platform 71 and can move relative to the laminating platform 71 for pressing against the battery cell.

It should be noted that after the clamping claw 72 clamps the second composite material strip 304 and folds the second composite material strip 304 and places it on the laminating platform 71, the pressing plate 73 presses the battery cell, and the clamping claw 72 is withdrawn, and then the pressing member 74 presses the battery cell, and the pressing plate 73 is withdrawn, so as to prevent the battery cell from loosening or displacement during a laminating process, which affects accuracy of lamination.

In addition, the second laminating device 60 in the second embodiment may also be provided with a pressing plate and a pressing member for tightly pressing the battery cell.

Please refer to FIGS. 5-7, an embodiment is used as an example to illustrate: initially, a piece of second sheet material 302 is placed at the head end of the first composite strip 200 (corresponding to a position of a first folded sheet), and then the first sheet material 301 and the second sheet material 302 corresponding to a third folded sheet are placed on the first composite strip 200, and then the first sheet material 301 and the second sheet material 302 corresponding to a fifth folded sheet are placed; in such a way, the first sheet material 301 and the second sheet material 302 are repeatedly placed between every other folded sheet, and the first sheet material 301 and the second sheet material 302 placed each time correspond to a same folded sheet. The first sheet material 301 and the second sheet material 302 are placed on the first composite material strip 200 and then are sequentially processed by a feeding mechanism, a heating mechanism, and a rolling mechanism to form the third composite strip 304. In other words, the head end is the third stacking component 3041 with only the second sheet material 302 when folded in this embodiment.

In other embodiments, the third stacking component 3041 of the third composite strip 304 or the fourth stacking component 3042 of the third composite strip 304 may be located at the head end when folded. Folding methods in the three embodiments are same. Here, with reference to FIGS. 5-7 in combination, the head end is the third stacking component 3041 with only the second sheet material 302 when folded is used as an example for description:

Before grabbing, the pressing plate 73 moves a position to prevent interference, and the clamping claw 72 grabs the third composite material strip 304 at the material discharge end of the second composite mechanism 40 and horizontally moves it to the laminating platform 71. At this time, the third stacking component 3041 with only the second sheet material 302 at the head end of the first composite material strip 200 is in contact with the laminating platform 71, and then the pressing plate 73 presses downward to compress the third stacking component 3041 tightly, and the clamping claw 72 is withdrawn and returned to the material discharge end of the second composite mechanism 40 to continue to grab a second third stacking component 3041, and then the pressing member 74 presses against the third stacking component 3041, and the pressing plate 73 is withdrawn after pressing of the pressing member 74.

Next, the clamping claw 72 grabs the second third stacking component 3041 and horizontally moves it to the laminating platform 71, and the pressing member 74 keeps tightly pressing the second third stacking component 3041 and descends along with the laminating platform 71; the third stacking component 3041 at the head end of the second composite material strip 304 descends accordingly. When the clamping claw 72 grabs the second third stacking component 3041 and horizontally moves it to the laminating platform 71, the fourth stacking component 3042 adjacent to the third stacking component 3041 at the head end will cover the third stacking component 3041 at the head end. Moreover, the grabbed third stacking component 3041 will also cover the fourth stacking component 3042, so as to perform folding.

After folding, the pressing plate 73 presses downward tightly again, and then the clamping claw 72 is withdrawn to continue to grab a sequential third stacking component 3041, and then the pressing member 74 is pulled out and presses against a yet another third stacking component 3041 again and descends with the laminating platform 71.

It should be appreciated that a grabbing method of the clamping claw 72 is to grab at intervals of one stacking component, namely, there is an interval of one stacking component between the stacking component grabbed currently and the stacking component grabbed at a previous time. In a case of the third stacking component 3041 grabbed as described above, as the third stacking component 3041 and the fourth stacking component 3042 are alternately connected, when the clamping claw 72 grabs the second third stacking component 3041 directly above a previous third stacking component 3041, the fourth stacking component 3042 between the two third stacking components 3041 will be folded.

It should be appreciated that actions of the clamping claw 72 and the laminating platform 71 of the third laminating device 70 in this embodiment are same as those of the clamping claw 62 and the laminating platform 61 in the second laminating device 60 in the above-mentioned embodiment.

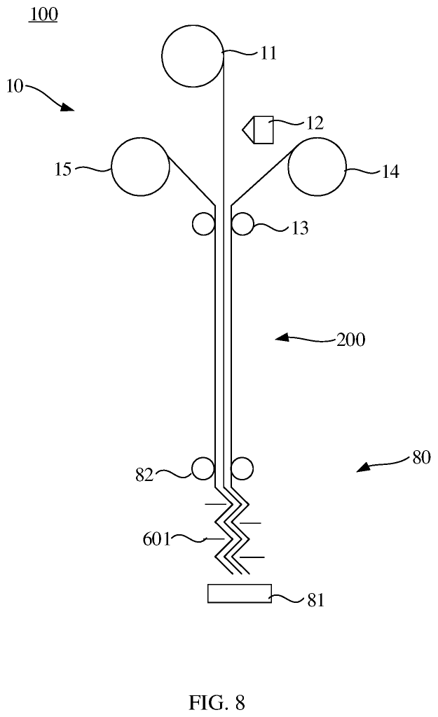

Referring to FIG. 8, in a fourth embodiment, the laminating machine 100 further includes a fourth laminating device 80. The fourth laminating device 80 is disposed downstream of the first composite mechanism 13 and is configured to fold the first composite material strip 200 along the creases. During a folding process, a third sheet material 601 is placed on the first diaphragm 202 and the second diaphragm 203, so that the first diaphragm 202, the folded sheet, the second diaphragm 203, and the third sheet material 601 are sequentially stacked to form a battery cell.

Furthermore, the fourth laminating device 80 includes a laminating platform 81 and a clamping roller 82. The clamping roller 82 is disposed downstream of the first composite mechanism 13, and the laminating platform 81 is disposed downstream of the clamping roller 82 and below the clamping roller 82. The first composite material strip 200 is conveyed to the laminating platform 81 after passing through the clamping roller 82. The clamping roller 82 and the laminating platform 81 can move relative to each other in a horizontal direction, and a moving direction is perpendicular to the first composite material strip 200.

After the head end of the first composite material strip 200 is attached to the laminating platform 81, the clamping roller 82 moves relative to the laminating platform 81 in conjunction with gravity of the first composite material strip 200 to realize folding of the first composite material strip 200. The third sheet material 601 may be placed between the first diaphragms 202 or between the second diaphragms 203 to be folded together during the folding process.

Specifically, after the head end of the first composite material strip 200 is attached to the laminating platform 81, a third sheet material 601 is laid on the first composite material strip 200, and then the clamping roller 82 moves relative to the laminating platform 81, and the first composite material 200 is folded and covers on the placed third sheet material 601 before the folding, and then the third sheet material 601 is placed on the folded first composite material 200, and above operations are repeated.

It should be appreciated that the third sheet material 601 in this embodiment is same as the first sheet material 301 and the second sheet material 302 in the above-mentioned embodiments, and are all pole sheets. In addition, a fourth laminating device 80 further includes a conveying mechanism, and the conveying mechanism is configured to convey the third sheet material 601 to the first diaphragm 202 and the second diaphragm 203, and the conveying mechanism may be a manipulator or other conveying mechanism that can perform conveying of the third sheet material 601, which is not limited here.

The clamping roller 82 and the laminating platform 81 can move relative to each other in the horizontal direction. The clamping roller 82 is fixed and the laminating platform 81 is movable, or the laminating platform 81 is fixed and the clamping roller 82 is movable. In addition, the laminating platform 81 can also ascend and descend in this embodiment, for example, the laminating platform 81 descends during a process of forming the battery cell on the laminating platform 81 to ensure that the first composite strip 200 is folded at a same height.

In combination with the above-mentioned embodiments, it should be noted that the first sheet material 301, the second sheet material 302, the third sheet material 601, and the folded sheet in the above-mentioned embodiments all are pole sheets, and the first diaphragm 202 and the second diaphragm 203 both are diaphragms, so the battery cell, which is formed by folding, is actually a structure formed by stacking the pole sheets and the diaphragms multiple times.

In a specific embodiment, the first electrode material strip 201 is a negative electrode, and the first sheet material 301, the second sheet material 302, and the third sheet material 601 are positive pole sheets. In another specific embodiment, the first electrode material strip 201 is a positive electrode, and the first sheet material 301, the second sheet material 302, and the third sheet material 601 are negative pole sheets.

Technical features of the above-mentioned embodiments may be combined by any means. To provide a concise description, not all of the possible combinations of the technical features are described herein. However, as long as no contradiction is generated, any combination of the technical features should be within the scope of the present disclosure.

The above-mentioned embodiments may illustrate only some implementations of the present disclosure. The description may be quite specific and detailed, but should not be considered to limit the scope of the present disclosure. It should be noted that, any ordinary skilled in the art, without departing from the concept of the present disclosure, may perform various transformation and improvement which should be within the scope of the present disclosure. Therefore, the scope of the present disclosure shall be subject to the claims.

What is claimed is:

1. A composite device, comprising:
a first electrode material strip unwinding mechanism configured to unwind a first electrode material strip;
a crease mechanism disposed downstream of the first electrode material strip unwinding mechanism and configured to form a plurality of creases spaced apart along a length direction of a first electrode material strip and extending along a width direction of the first electrode material strip on the first electrode material strip in a path; and
a first composite mechanism disposed downstream of the crease mechanism and configured to combine a first diaphragm and a second diaphragm on opposite sides of the first electrode material strip to form a first composite material strip.

2. The composite device as claimed in claim 1, wherein the composite device further comprises a first diaphragm unwinding mechanism and a second diaphragm unwinding mechanism, and the first diaphragm unwinding mechanism and the second diaphragm unwinding mechanism are both disposed upstream of the first composite mechanism; the first diaphragm unwinding mechanism is configured to unwind the first diaphragm, and the second diaphragm unwinding mechanism is configured to unwind the second diaphragm.

3. The composite device as claimed in claim 1, wherein the crease mechanism comprises a laser cutting head or a cutter.

4. The composite device as claimed in claim 1, wherein the creases are penetrating holes sequentially spaced apart along the width direction of the first electrode material strip and penetrating the first electrode material strip along its thickness direction.

5. The composite device as claimed in claim 4, wherein the penetrating holes comprise one or more of circular holes, rectangular holes, or strip holes.

6. The composite device as claimed in claim 1, wherein the creases are folded areas extending along the width direction of the first electrode material strip, and a thickness of the folded areas of the first electrode material strip is less than a thickness of other positions of the first electrode material strip.

7. A laminating machine, comprising a composite device, wherein the composite device comprises:
a first electrode material strip unwinding mechanism configured to unwind a first electrode material strip;
a crease mechanism disposed downstream of the first electrode material strip unwinding mechanism and configured to form a plurality of creases spaced apart along a length direction of a first electrode material strip and extending along a width direction of the first electrode material strip on the first electrode material strip in a path; and
a first composite mechanism disposed downstream of the crease mechanism and configured to combine a first diaphragm and a second diaphragm to form a first composite material strip on opposite sides of the first electrode material strip.

8. The laminating machine as claimed in claim 7, wherein a folded sheet is formed between two adjacent creases on the first electrode material strip;
the laminating machine further includes a first sheet material device, a second sheet material device, and a second composite mechanism, the first sheet material device is configured to dispose a plurality of first sheet materials on a side surface of the first composite material strip, and the second sheet material device is configured to dispose a plurality of second sheet materials on another side surface of the first composite material strip; and the first sheet materials and the second sheet materials are alternately spaced apart along a length direction of the first composite material strip, and two adjacent first sheet materials and second sheet materials along the length direction of the first composite material strip correspond to two adjacent folded sheets, respectively;
the second composite mechanism is disposed downstream of the first sheet material device and the second sheet material device and is configured to combine the first sheet material and the second sheet material with the first composite material strip, so that the first sheet material and the second sheet material are attached to the first composite material strip to form a second composite material strip.

9. The laminating machine as claimed in claim 8, wherein the second composite material strip comprises a plurality of first stacking components and a plurality of second stacking components, and the first stacking components and the second stacking components are alternately connected; the first stacking components comprise the first sheet material, the first diaphragm, the folded sheet, and the second diaphragm that are stacked in sequence, and the second stacking components comprise the second sheet material, the second diaphragm, the folded sheet, and the first diaphragm that are stacked in sequence;
the laminating machine further comprises a first laminating device, the first laminating device is disposed downstream of the second composite mechanism and is configured to perform folding on the second composite material strip along the creases, so that a battery cell is formed by alternately stacking the plurality of first stacking components and the plurality of second stacking components.

10. The laminating machine as claimed in claim 7, wherein a folded sheet is formed between two adjacent creases on the first electrode material strip;
the laminating machine further comprises a first sheet material device, a second sheet material device, and a second composite mechanism; the first sheet material device is configured to dispose a plurality of first sheet materials on a side surface of the first composite material strip, the second sheet material device is configured to dispose a plurality of second sheet materials on another side surface of the first composite material strip, and the first sheet material and the second sheet material are disposed on two sides of one of two adjacent folded sheets;
the second composite mechanism is disposed downstream of the first sheet material device and the second sheet material device and is configured to combine the first sheet material and the second sheet material with the first composite material strip, so that the first sheet material and the second sheet material are attached to the first composite material strip to form a third composite material strip.

11. The laminating machine as claimed in claim 10, wherein the third composite material strip comprises a plurality of third stacking components and a plurality of fourth stacking components, and the third stacking components and the fourth stacking components are alternately connected; the third stacking components comprise the first sheet material, the first diaphragm, the folded sheet, the second diaphragm, and the second sheet material that are stacked in sequence, and the fourth stacking components comprise the first diaphragm, the folded sheet, and the second diaphragm that are stacked in sequence;
the laminating machine further comprises a third laminating device, and the third laminating device is disposed downstream of the second composite mechanism and is configured to fold the third composite material strip along the creases, so that the plurality of third stacking components and the plurality of fourth stacking components are alternately stacked to form a battery cell.

12. The laminating machine as claimed in claim 7, wherein a folded sheet is formed between two adjacent creases on the first electrode material strip;
the laminating machine further comprises a fourth laminating device, and the fourth laminating device is disposed downstream of the first composite mechanism and is configured to fold the first composite material strip along the creases; and during a folding process, a third sheet material is placed on the first diaphragm and the second diaphragm in sequence, so that the first diaphragm, the folded sheet, the second diaphragm, and the third sheet material are sequentially stacked to form a battery cell.
